(19) United States
(12) Patent Application Publication
(10) Pub. No.: US 2026/0280758 A1
(43) Pub. Date: Sep. 17, 2026

(54) DYNAMIC CODE BLOCK BUNDLE INTERLEAVING

(71) Applicant: QUALCOMM Incorporated, San Diego, CA (US)

(72) Inventors: Somsubhra BARIK, San Diego, CA (US); Jing SUN, San Diego, CA (US); Tao LUO, San Diego, CA (US)

(21) Appl. No.: 19/544,909

(22) Filed: Feb. 19, 2026

Related U.S. Application Data
(60) Provisional application No. 63/771,389, filed on Mar. 13, 2025.

(51) Int. Cl. H04L 1/00

(52) U.S. Cl. CPC H04L 1/0057; H04L 1/0071

(57) ABSTRACT

This disclosure provides methods, components, devices and systems for dynamic code block bundle interleaving. For example, a device may determine a code block bundle that includes multiple code blocks that include data units (e.g., resource blocks or resource elements) that are to be interleaved. The quantity of code blocks for a bundle may be determined based on various parameters associated with a transport block (TB). The resource elements of a first code block may be interleaved with resource elements of other code blocks in the code block bundle such that resource elements of multiple code blocks are interleaved across a set of resource elements of a orthogonal frequency division multiplexed (OFDM) symbol. Because the resource elements are interleaved, the resource blocks of one code block are spread across (at least partially) a bandwidth of a symbol, which may lead to improved frequency diversity.

### CROSS REFERENCES

The present Application for Patent claims benefit of U.S. Provisional Patent Application No. 63/771,389 by BARIK et al., entitled “DYNAMIC CODE BLOCK BUNDLE INTERLEAVING,” filed Mar. 13, 2025, assigned to the assignee hereof, and expressly incorporated herein.

### TECHNICAL FIELD

This disclosure relates generally to wireless communication, and more specifically to systems, devices, methods, and techniques associated with dynamic code block bundle interleaving.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

Wireless communications systems may support communication of data of a transport block (TB), which may be segmented into one or more code blocks before transmission. Accordingly, a single transport block contains one or more code blocks, which are processed independently but transmitted together. This segmentation and individual processing of code blocks may support error correction encoding schemes, among other benefits and techniques.

### SUMMARY

The systems, methods, and devices of this disclosure each have several innovative aspects, no single one of which is solely responsible for the desirable attributes disclosed herein. The following is a summary of some non-limiting aspects of the disclosure:

Wireless communications systems may support communication of data of a transport block (TB), which may be segmented into one or more code blocks before transmission. Accordingly, a single transport block contains one or more code blocks, which are processed independently but transmitted together. This segmentation and individual processing of code blocks may support error correction encoding schemes, among other benefits and techniques. In some cases, under higher order modulation and high rank transmissions, one code block may not be spread over a wider bandwidth, which may lead to transmission with low frequency diversity. High frequency diversity may combat the effects of frequency-selective fading and interference, which may degrade signal quality. Thus, low frequency diversity may have negative impacts such as low signal quality and increased interference.

Techniques described herein support encoding of code blocks to improve frequency diversity for transmission of transport blocks. For example, using the techniques described herein, resource blocks (RBs) of a code block may be interleaved with resource blocks of other code blocks such that resource blocks of multiple code blocks are interleaved across a set of resource elements of a symbol. Because the resource blocks are interleaved, the resource blocks of one code block are spread across (at least partially) a bandwidth of a symbol, which may lead to improved frequency diversity. To support such techniques, a transmitter device (e.g., a user equipment (UE) or network entity) may determine the quantity of code blocks to include in a code block bundle that is to be encoded using an interleaving pattern. The quantity of code blocks for a bundle may be determined based on various parameters, such as the quantity of resource elements in a symbol, the quantity of resource elements per code block, the quantity of code blocks in the transport block, the quantity of symbols allocated for transmission of the transport block, an average quantity of resource elements per symbol, a maximum code block size, a coding rate for the transport block, a modulation order for the transport block, a rank to be used for transmission of the transport block, or any combination thereof. These parameters (or information to use to derive one or more of these parameters) may be communicated by a scheduling device.

After determining the quantity of code blocks of the code block bundle, the transmitting device may encode the code blocks of the code block bundle in an interleaving pattern in resource elements of the symbol. The transmitting device may transmit the interleaved code blocks using the symbol, and may use similar interleaving techniques across multiple symbols of the transport block allocation. The resulting transmission of the transport block may be associated with increased frequency diversity relative to transport block transmissions without the interleaved code blocks. As such, the resulting communications may be associated with improved signal quality and reduced interference.

A method for wireless communications by a wireless device is described. The method may include participating in communication of one or more communication parameters associated with a transmission of a transport block including a set of multiple code blocks, where the one or more communication parameters are indicative of a first quantity of resource elements included in a symbol allocated for the transmission of the transport block, determining a quantity of code blocks for a set of code blocks included in the set of multiple code blocks using the first quantity of resource elements in the symbol and a second quantity of resource elements per code block of the set of multiple code blocks, encoding, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks, and transmitting the interleaved resource elements of the quantity of code blocks using at least the portion of the first quantity of resource elements of the symbol.

A wireless device for wireless communications is described. The wireless device may include a processing system that includes processor circuitry and memory circuitry that stores code. The processing system may be configured to cause the wireless device to participate in communication of one or more communication parameters associated with a transmission of a transport block including a set of multiple code blocks, where the one or more communication parameters are indicative of a first quantity of resource elements included in a symbol allocated for the transmission of the transport block, determine a quantity of code blocks for a set of code blocks included in the set of multiple code blocks using the first quantity of resource elements in the symbol and a second quantity of resource elements per code block of the set of multiple code blocks, encode, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks, and transmit the interleaved resource elements of the quantity of code blocks using at least the portion of the first quantity of resource elements of the symbol.

Another wireless device for wireless communications is described. The wireless device may include means for participating in communication of one or more communication parameters associated with a transmission of a transport block including a set of multiple code blocks, where the one or more communication parameters are indicative of a first quantity of resource elements included in a symbol allocated for the transmission of the transport block, means for determining a quantity of code blocks for a set of code blocks included in the set of multiple code blocks using the first quantity of resource elements in the symbol and a second quantity of resource elements per code block of the set of multiple code blocks, means for encoding, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks, and means for transmitting the interleaved resource elements of the quantity of code blocks using at least the portion of the first quantity of resource elements of the symbol.

A non-transitory computer-readable medium storing code for wireless communications is described. The code may include instructions executable by one or more processors to participate in communication of one or more communication parameters associated with a transmission of a transport block including a set of multiple code blocks, where the one or more communication parameters are indicative of a first quantity of resource elements included in a symbol allocated for the transmission of the transport block, determine a quantity of code blocks for a set of code blocks included in the set of multiple code blocks using the first quantity of resource elements in the symbol and a second quantity of resource elements per code block of the set of multiple code blocks, encode, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks, and transmit the interleaved resource elements of the quantity of code blocks using at least the portion of the first quantity of resource elements of the symbol.

In some examples of the method, wireless devices, and non-transitory computer-readable medium described herein, determining the quantity of code blocks may include operations, features, means, or instructions for determining the quantity of code blocks within the set of code blocks using a total quantity of code blocks of the set of multiple code blocks of the transport block and a quantity of symbols allocated for transmission of the transport block.

Some examples of the method, wireless devices, and non-transitory computer-readable medium described herein may further include operations, features, means, or instructions for determining the total quantity of code blocks using a transport block size of the transport block.

Some examples of the method, wireless devices, and non-transitory computer-readable medium described herein may further include operations, features, means, or instructions for determining the quantity of symbols allocated for transmission of the transport block using a time domain resource allocation included in the one or more communication parameters.

In some examples of the method, wireless devices, and non-transitory computer-readable medium described herein, determining the quantity of code blocks may include operations, features, means, or instructions for determining the quantity of code blocks within the set of code blocks using an average quantity of resource elements per symbol allocated for transmission of the transport block and the second quantity of resource elements per code block.

Some examples of the method, wireless devices, and non-transitory computer-readable medium described herein may further include operations, features, means, or instructions for determining the second quantity of resource elements per code block using a maximum code block size, a coding rate for the transport block, a modulation order for the transport block, and a rank associated with transmission of the transport block.

In some examples of the method, wireless devices, and non-transitory computer-readable medium described herein, the one or more communication parameters include a frequency domain resource allocation, a modulation and coding scheme, a rank associated with transmission of the transport block, a time domain resource allocation, a maximum code block size, or any combination thereof and the quantity of code blocks may be determined using the one or more communication parameters.

Some examples of the method, wireless devices, and non-transitory computer-readable medium described herein may further include operations, features, means, or instructions for participating in communication of a maximum supported quantity of code blocks for the set of code blocks including the resource blocks that may be interleaved, where the resource blocks included in the first code block of the set of code blocks may be interleaved with resource blocks included in the one or more additional code blocks in the set of code blocks in accordance with the maximum supported quantity of code blocks.

A method for wireless communications by a wireless device is described. The method may include participating in communication of one or more communication parameters associated with a transmission of a transport block including a set of multiple code blocks, where the one or more communication parameters are indicative of a first quantity of resource elements included in an symbol allocated for the transmission of the transport block, determining a quantity of code blocks for a set of code blocks included in the set of multiple code blocks using the first quantity of resource elements in the symbol and a second quantity of resource elements per code block of the set of multiple code blocks, receiving, using at least a portion of the first quantity of resource elements of the symbol, the set of code blocks, where resource elements included in a first code block in the set of code blocks are interleaved with resource elements included in one or more additional code blocks in the set of code blocks, and decoding each code block of the set of code blocks in accordance with the resource elements included in the first code block being interleaved with resource elements included in the one or more additional code blocks.

A wireless device for wireless communications is described. The wireless device may include a processing system that includes processor circuitry and memory circuitry that stores code. The processing system may be configured to cause the wireless device to participate in communication of one or more communication parameters associated with a transmission of a transport block including a set of multiple code blocks, where the one or more communication parameters are indicative of a first quantity of resource elements included in an symbol allocated for the transmission of the transport block, determine a quantity of code blocks for a set of code blocks included in the set of multiple code blocks using the first quantity of resource elements in the symbol and a second quantity of resource elements per code block of the set of multiple code blocks, receive, using at least a portion of the first quantity of resource elements of the symbol, the set of code blocks, where resource elements included in a first code block in the set of code blocks are interleaved with resource elements included in one or more additional code blocks in the set of code blocks, and decode each code block of the set of code blocks in accordance with the resource elements included in the first code block being interleaved with resource elements included in the one or more additional code blocks.

Another wireless device for wireless communications is described. The wireless device may include means for participating in communication of one or more communication parameters associated with a transmission of a transport block including a set of multiple code blocks, where the one or more communication parameters are indicative of a first quantity of resource elements included in an symbol allocated for the transmission of the transport block, means for determining a quantity of code blocks for a set of code blocks included in the set of multiple code blocks using the first quantity of resource elements in the symbol and a second quantity of resource elements per code block of the set of multiple code blocks, means for receiving, using at least a portion of the first quantity of resource elements of the symbol, the set of code blocks, where resource elements included in a first code block in the set of code blocks are interleaved with resource elements included in one or more additional code blocks in the set of code blocks, and means for decoding each code block of the set of code blocks in accordance with the resource elements included in the first code block being interleaved with resource elements included in the one or more additional code blocks.

A non-transitory computer-readable medium storing code for wireless communications is described. The code may include instructions executable by one or more processors to participate in communication of one or more communication parameters associated with a transmission of a transport block including a set of multiple code blocks, where the one or more communication parameters are indicative of a first quantity of resource elements included in an symbol allocated for the transmission of the transport block, determine a quantity of code blocks for a set of code blocks included in the set of multiple code blocks using the first quantity of resource elements in the symbol and a second quantity of resource elements per code block of the set of multiple code blocks, receive, using at least a portion of the first quantity of resource elements of the symbol, the set of code blocks, where resource elements included in a first code block in the set of code blocks are interleaved with resource elements included in one or more additional code blocks in the set of code blocks, and decode each code block of the set of code blocks in accordance with the resource elements included in the first code block being interleaved with resource elements included in the one or more additional code blocks.

In some examples of the method, wireless devices, and non-transitory computer-readable medium described herein, determining the quantity of code blocks may include operations, features, means, or instructions for determining the quantity of code blocks within the set of code blocks using a total quantity of code blocks of the set of multiple code blocks of the transport block and a quantity of symbols allocated for transmission of the transport block.

Some examples of the method, wireless devices, and non-transitory computer-readable medium described herein may further include operations, features, means, or instructions for determining the total quantity of code blocks using a transport block size of the transport block.

Some examples of the method, wireless devices, and non-transitory computer-readable medium described herein may further include operations, features, means, or instructions for determining the quantity of symbols allocated for receipt of the transport block using a time domain resource allocation included in the one or more communication parameters.

In some examples of the method, wireless devices, and non-transitory computer-readable medium described herein, determining the quantity of code blocks may include operations, features, means, or instructions for determining the quantity of code blocks within the set of code blocks using an average quantity of resource elements per symbol allocated for receipt of the transport block and the second quantity of resource elements per code block.

Some examples of the method, wireless devices, and non-transitory computer-readable medium described herein may further include operations, features, means, or instructions for determining the second quantity of resource elements per code block using a maximum code block size, a coding rate for the transport block, a modulation order for the transport block, and a rank associated with receipt of the transport block.

In some examples of the method, wireless devices, and non-transitory computer-readable medium described herein, the one or more communication parameters include a frequency domain resource allocation, a modulation and coding scheme, a rank associated with receipt of the transport block, a time domain resource allocation, a maximum code block size, or any combination thereof and the quantity of code blocks may be determined using the one or more communication parameters.

Some examples of the method, wireless devices, and non-transitory computer-readable medium described herein may further include operations, features, means, or instructions for participating in communication of a maximum supported quantity of code blocks for the set of code blocks including the resource blocks that may be interleaved, where the first code block of the set of code blocks may be interleaved with resource blocks included in the one or more additional code blocks in the set of code blocks in accordance with the maximum supported quantity of code blocks.

### BRIEF DESCRIPTION OF THE DRAWINGS

FIG. 1 shows an example of a wireless communication system.

FIG. 2 shows an example of a resource diagram that supports dynamic code block bundle interleaving.

FIG. 3 shows a block diagram of a processing system that supports dynamic code block bundle interleaving.

FIG. 4 shows a diagram of a system including a UE that supports dynamic code block bundle interleaving in accordance with one or more aspects of the present disclosure.

FIG. 5 shows a diagram of a system including a network entity that supports dynamic code block bundle interleaving in accordance with one or more aspects of the present disclosure.

FIGS. 6 and 7 show flowcharts illustrating methods that support dynamic code block bundle interleaving.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, transport blocks (TBs) may be segmented into one or more code blocks for transmission. Accordingly, a single transport block contains one or more code blocks, which are processed independently but transmitted together. This segmentation and individual processing of code blocks may support error correction encoding schemes, among other benefits and techniques. In some cases, under higher order modulation and high rank transmissions, one code block may not be spread over a wider bandwidth, which may lead to transmission with low frequency diversity. High frequency diversity may combat the effects of frequency-selective fading and interference, which may degrade signal quality. Thus, low frequency diversity may have negative impacts such as low signal quality and increased interference.

Aspects of the subject matter described in this disclosure relate to encoding of code blocks to improve frequency diversity. For example, using the techniques described herein, resource blocks (RBs) of a code block may be interleaved with resource blocks of other code blocks such that resource blocks of multiple code blocks are interleaved across a set of resource elements of a symbol. In some other aspects, one or more resource elements of a code block may be interleaved. Thus, the interleaving unit may be 1 resource element, 1 resource block, multiple resource elements, and/or multiple resource blocks. Because the resource blocks or resource elements are interleaved, the resource blocks of one code block are spread across (at least partially) a bandwidth of a symbol, which may lead to improved frequency diversity. To support such techniques, a transmitter device (e.g., a user equipment (UE) or network entity) may determine the quantity of code blocks to include in a code block bundle that is to be encoded using an interleaving pattern. The quantity of code blocks for a bundle may be determined based on various parameters, such as the quantity of resource elements in a symbol, the quantity of resource elements per code block, the quantity of code blocks in the transport block, the quantity of symbols allocated for transmission of the transport block, an average quantity of resource elements per symbol, a maximum code block size, a coding rate for the transport block, a modulation order for the transport block, a rank to be used for transmission of the transport block, or any combination thereof. These parameters (or information to use to derive one or more of these parameters) may be communicated by a scheduling device. Various techniques for determining the quantity of code blocks per code block bundle are described herein.

Thus, after determining the quantity of code blocks of the code block bundle, the transmitting device may encode the code blocks of the code block bundle in an interleaving pattern in resource elements of the symbol. The transmitting device may transmit the interleaved code blocks using the symbol, and may use similar interleaving techniques across multiple symbols of the transport block allocation. The resulting transmission of the transport block may be associated with increased frequency diversity relative to transport block transmissions without the interleaved code blocks.

Particular aspects of the subject matter described in this disclosure can be implemented to realize one or more of the following potential advantages. In some examples, by interleaving code blocks of a transport block across resource elements of a symbol, the described techniques can be used to improve frequency diversity, which may lead to improved signal quality and reduced interference. These and other techniques are described in further detail with respect to the figures.

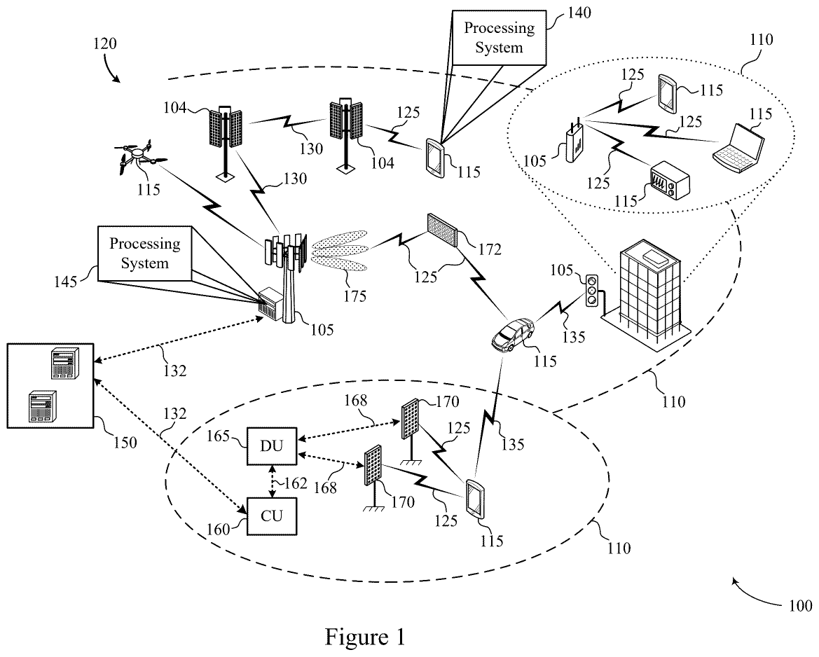

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115. As described herein, a wireless device may be an example of a UE 115 or a network entity 105.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

A RAT may establish various allocations of REs (such as in accordance with an RB allocation, in a pattern in the time and frequency domains) for certain types of signals. For example, patterns of REs may be allocated to signals associated with physical channels (such as physical layer channels) and reference signals, which may be multiplexed using time division multiplexing (TDM), frequency division multiplexing (FDM), or hybrid TDM-FDM techniques.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices in the wireless communication system 100 (such as network entities 105, UEs 115) may modulate and code information prior to transmission of a signal (such as of a physical channel). A modulation and coding scheme (MCS) may define how modulation and coding is to be performed, which may include an implementation in accordance with a modulation order and a target code rate. A code rate may be achieved using a channel coding scheme such as forward error correction (FEC) (such as to add redundancy). Examples of FEC include block codes, convolutional codes, and linear error-correcting codes. At a receiver (such as to demodulate modulation symbols of a physical channel), a decoder may employ probabilistic or iterative techniques to perform soft decision-making, and code blocks for bit streams may employ a check code (such as a cyclic redundancy check (CRC) code, a low-density parity-check (LDPC)) to detect and correct decoding errors.

Devices of the wireless communication system 100 may be configured to support one or more aspects of the described techniques for dynamic code block bundle interleaving. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improved frequency diversity for code blocks, resulting in improved signal quality and reduced interference.

The wireless communications system 100 may support encoding of code blocks to improve frequency diversity for transmission of transport blocks. For example, using the techniques described herein, a transmitting device (e.g., the UEs 115 and/or the network entities 105) may interleave resource blocks (RBs) of a code block with resource blocks of other code blocks such that resource blocks of multiple code blocks are interleaved across a set of resource elements of a symbol. Because the resource blocks are interleaved, the resource blocks of one code block are spread across (at least partially) a bandwidth of a symbol, which may lead to improved frequency diversity. To support such techniques, the transmitting device (e.g., the UE 115 or the network entity 105) may determine the quantity of code blocks to include in a code block bundle that is to be encoded using an interleaving pattern. The quantity of code blocks for a bundle may be determined based on various parameters, such as the quantity of resource elements in a symbol, the quantity of resource elements per code block, the quantity of code blocks in the transport block, the quantity of symbols allocated for transmission of the transport block, an average quantity of resource elements per symbol, a maximum code block size, a coding rate for the transport block, a modulation order for the transport block, a rank to be used for transmission of the transport block, or any combination thereof. These parameters (or information to use to derive one or more of these parameters) may be communicated by a scheduling device (e.g., the network entity 105).

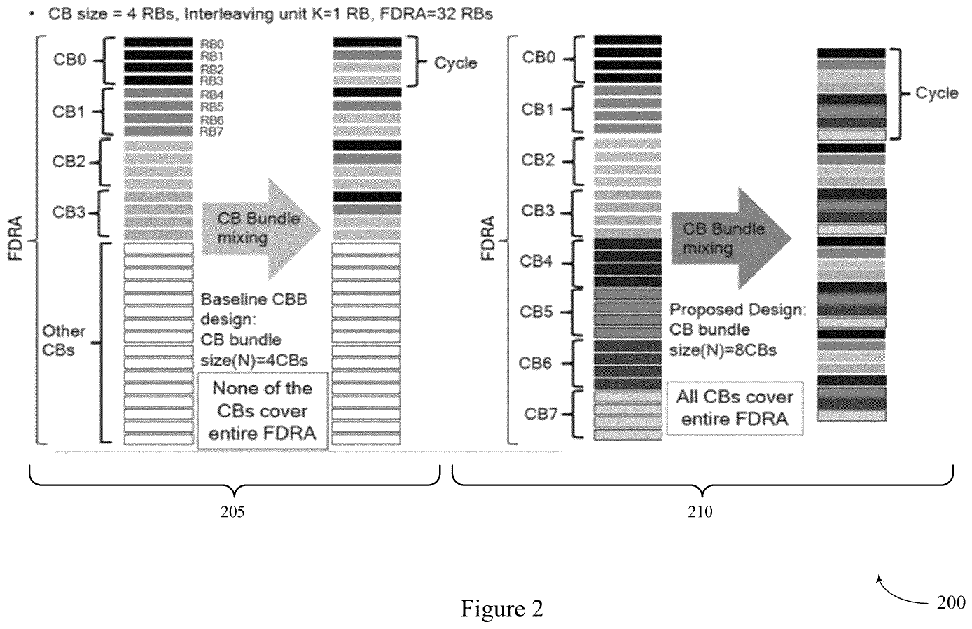

FIG. 2 shows an example of a resource diagram 200 that supports dynamic code block bundle interleaving. The resource diagram 200 may implement or may be implemented by aspects of the wireless communications system 100 of FIG. 1. For example, a transmitter device, such as the UE 115 or the network entity 105 of FIG. 1 may implement aspects of the resource diagram 200.

As described herein, a TB, which may contain user data (e.g., data of a physical downlink shared channel (PDSCH) or a physical uplink shared channel (PUSCH)) may represent user data that is packaged for transmission over the air interface. For example, the TB may be an example of a basic data unit that is delivered between the MAC layer and PHY layer. The TB may be segmented into one or more code blocks to support error correction coding techniques and mapping to physical communication resources (e.g., time and frequency resources of a channel). For example, the transport block is first segmented into one or more code blocks before transmission in wireless systems. This segmentation is used because, while a transport block can be quite large, there are practical limitations on the maximum size that error correction coding schemes can effectively handle. Each code block is individually processed with error detection and correction coding, using methods such as Turbo coding or Low-Density Parity Check (LDPC) coding. The size of code blocks may be chosen to improve the performance of these channel coding schemes while maintaining reasonable processing complexity.

This segmentation and individual processing of code blocks may provide several advantages. If errors occur during transmission, the affected code block may be retransmitted rather than the entire transport block, improving efficiency. Additionally, the parallel processing of code blocks can reduce latency in both transmission and reception, as different code blocks can be processed simultaneously by different hardware units. After processing, the code blocks are concatenated back together to reform the transport block for transmission. The receiver then performs the reverse process, separating the transport block into its constituent code blocks for decoding, error checking, and reconstruction of the original data. This structured approach to handling data helps maintain reliability and efficiency in wireless communications while managing the complexity of error correction processing.

In wireless communications systems, the code block size may be limited. Under higher order modulation and high rank transmission, code blocks may be rate-matched to resource in the following order: (1) spatial layer(s), (2) frequency domain resources, and (3) time domain resources. As a result, a single code block may not be spread over a wider bandwidth, which may lead to transmissions with low frequency diversity. For example, for an 8K bit code block with code rate 0.9 using 256QAM and rank 4 transmission, the code block may occupy about 23 resource blocks.

As illustrated in the codebook bundling diagram 205, code blocks may be bundled and interleaved to increase frequency diversity. As illustrated, each code block (e.g., CB0, CB1, etc.) is spread across a higher quantity of clusters along the allocated bandwidth. Each code block may be divided into interleavable chunks of smaller size and multiple code blocks are mixed together and thus each code block can be spread wider across the frequency bandwidth of a symbol. This is done by rate matching K REs at a time from each CB of a bundle in a round-robin manner. Each round-robin step constitutes a so-called ‘cycle’ of CB bundling.

One practical issue with code block bundle interleaving is the impact on the device (e.g., UE) memory storage and latency in demodulation. For example, on the receiver side, the code blocks in a bundle are to be fully received, equalized, and demodulated before any code block from that bundle can be decoded (e.g., due to error correction coding techniques). To support such techniques, increased memory capacity may be used to store the log-likelihood ratios (LLRs) of all code locks in a bundle before the code blocks are decoded (e.g., passed to the decoding component). Since decoding of a code blocks may not be initialized immediately (e.g., due to waiting for each code block of a bundle), the code block bundle interleaving stretches the timeline of decoding and may be unsuitable for traffic requiring quick turnaround (e.g., in ultra-reliable, low latency communications (URLLC)). For uplink traffic, memory capacity may not be an issue at a network entity 105, even if the code block bundle size is large. Moreover, memory capacity of a receiver device (e.g., a UE) may not be an issue in downlink, such as when a UE is a higher-tier/higher complexity device with increased storage. The code block bundling diagram 205 may use a fixed code block bundle size that is independent of resource allocation or channel, which may result in a limit in the overall frequency diversity applied to a code block.

To achieve improved diversity, as illustrated in code block bundling diagram 210, the scheduler (e.g., the network entity 105) may (e.g., dynamically) configure a code block bundle size such that all (or a portion thereof) code blocks contained within the duration of an orthogonal frequency division multiplexed (OFDM) symbol are interleaved together. As a result, each code block's footprint in the frequency domain is increased to cover the bandwidth of allocation.

To support such techniques, the code block bundle size may be dependent on the frequency domain allocation size and the quantity of resource elements occupied by each code block. This becomes relevant cases where the frequency domain resource allocation (FDRA) is continuous (such as in wideband deployments common to uplink implementations), and a code block may benefit from the diversity by spreading across the entire FDRA (or a portion thereof). For channels with low frequency selectivity, this technique may provide performance benefit over a baseline of no interleaving.

A code block bundle size (e.g., the quantity of code blocks that are to be interleaved together) may be dynamically chosen, configured, and/or indicated as a function of the FDRA (e.g., the quantity of resource elements in an OFDM symbol), a modulation and coding scheme (MCS) for the transmission, the rank of the transmission, among other parameters. For example, the bundle size may be approximately the same as the quantity of code blocks in an OFDM symbol to maximize the frequency diversity of each code block and to avoid excessive processing delay. The quantity of code blocks, K, in a bundle may be determined using the following equation:

$$K \approx \frac{Quantity of REs per OFDM symbol}{Quantity of REs per CB}$$

As such, the transmitting or scheduling device (e.g., the network entity) may group the N code blocks of a code word (e. into M bundles of approximately K code blocks each). As described herein, K may be determined using various techniques. Moreover, with K derived from the allocation of the MCS, rank, etc. associated with the transmission, no explicit signaling of K may be used, which may result in saving of signaling overhead. That is, as K may be derived based on parameters that may be signaled for scheduling the communication, additional signaling may not be required for signaling K.

In some cases, the code block bundle size (e.g., the quantity of code blocks in a set of code blocks of a bundle) may be determined using the resource allocation and the quantity of code blocks in the transport block, using the following equation:

$$K \approx \frac{Quantity of CBs}{Quantity of OFDM symbols}$$

The quantity of code blocks may be known by the devices based on the code block segmentation in accordance with the transport block size (TBS). The quantity of OFDM symbols may be derived from the time domain resource allocation (TDRA). The quantity of OFDM symbols may include symbols allocated for transmission of a demodulation reference signal (DMRS) or may exclude the DMRS symbols. For example, each DMRS symbol may be counted as a half symbol when data is frequency domain multiplexed (FDM) with the DMRS in every other resource element. The “~” operator may be considered a floor, ceiling, or another type of quantization. For example, not all integer values may be available, but the devices may choose the integer from a subset of available integers (e.g., configured or defined) with a range (e.g., configured or defined).

The code block bundle size may also be determined using an indirect computation. For example, the quantity of resource elements may be determined using one or more techniques (e.g., as E+ or E−, such as the quantity of resource elements difference by one). The indirect determination of the code block size may be based on the following equation:

$$K \approx \frac{Average quantity of REs per OFDM symbol}{Quantity of REs per CB ( E )}$$

E may be derived using one or more techniques such that E=E+ or E− using such computation techniques. The average quantity of resource elements per OFDM symbols may exclude or may include the resource elements reserved for reference signals, such as DMRS, tracking reference signals (TRS), channel state information reference signal (CSI-RS), phase tracking reference signals (PTRS), sounding reference signals (SRS), etc. As described herein, the “≈” operator may be considered a floor, ceiling, or another type of quantization. E (e.g., the quantity of resource elements per code block (CB)) may be determined using the MCS information as shown in the following equation:

$$E \approx \frac{maximum CB size}{Coding Rate} \times \frac{1}{Modulation order} \times \frac{1}{rank}$$

The coding rate and modulation order may be based on the MCS indicated by the scheduling downlink control information (DCI). The maximum code block size may be defined in the standards specification (e.g., 8448 bits for BG1, 3840 bits for BG2), where BG1 is Base Graph 1, and BG2 is Base Graph 2. This indirect computation approach for determining the quantity of resource elements per code block may be used cases when the DCI includes explicit MCS information (e.g., for the initial transmission and retransmissions). For a DCI that indicates a reserved MCS (used for retransmissions), the quantity of code blocks may be determined based on the quantity of code blocks and the quantity of OFDM symbols allocated for transmission of the transport block.

In some cases, a device may determine that K=0 or 1 or K is close to 1. This case may occur when the FDRA is small, the MCS is small, and/or when a code block covers a large portion of the FDRA. In such cases, if K=0, 1, or K is smaller than a threshold value (e.g., configured or defined), the device may skip the code block bundling interleaving, which may result in setting K=1.

Additionally, a device, such as a UE, may report a maximum supported code block bundle size (e.g., the maximum supported quantity of code blocks for a set of code blocks) to the scheduling device (e.g., the network entity). In such cases, if K is determined to be greater than the maximum supported code block bundle size, the devices may default to the maximum supported code block bundle size. Additionally, or alternatively, the scheduler may signal the parameters for the transport block such that K is less than or equal to the maximum.

As illustrated in code block bundling diagram 210, the eight code blocks (e.g., CB0 through CB7) are bundled into a code block bundle for a symbol, and the resource blocks of each code block are interleaved across the resource elements of the symbol. The interleaving unit is 1 resource block, such that one resource block of a code block is encoded to a resource element per cycle. However, the interleaving may be more than one. For example, if the interleaving unit is two, then two resource blocks of CB0 are encoded to two adjacent resource elements, then two resource blocks of CB1 are encoded to the next two adjacent resource elements, etc. It should be understood that FIG. 2 is an example interleaving techniques and that other techniques for interleaving are contemplated within the scope of the present disclosure. For example, different interleaving units, such as one or more resource elements may be used instead of one or more resource blocks. A resource block may include 12 resource elements. A receiving device (e.g., UE or network entity) may use the techniques described herein to determine the code block bundle size, and decode the code blocks of a symbol accordingly.

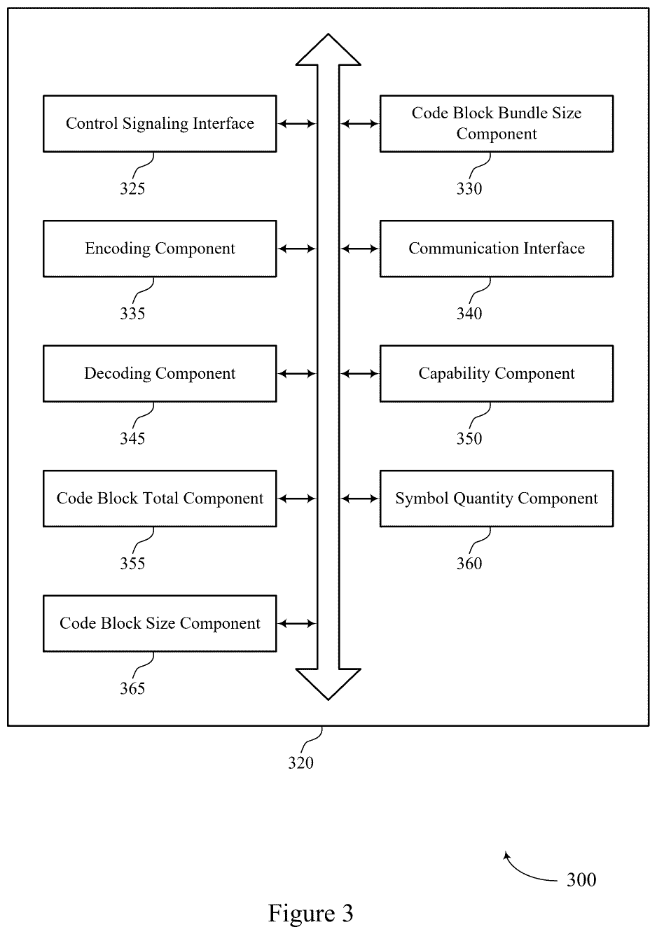

FIG. 3 shows an example of a processing system 320 that supports dynamic code block bundle interleaving. A processing system 320 may be an example of a processing system 145 (such as network entity 105) and may include a control signaling interface 325, a code block bundle size component 330, an encoding component 335, a communication interface 340, a decoding component 345, a capability component 350, a code block total component 355, a symbol quantity component 360, a code block size component 365, or any combination thereof. A processing system 320, or various component thereof, may be an example of means for performing (such as a means for causing a network entity 105 to perform) various techniques described herein.

The control signaling interface 325 may be configured to cause the UE 115 or the network entity 105 to participate in communication of one or more communication parameters associated with a transmission of a transport block including a set of multiple code blocks, where the one or more communication parameters are indicative of a first quantity of resource elements included in a symbol allocated for the transmission of the transport block. The code block bundle size component 330 may be configured to cause the UE 115 or the network entity 105 to determine a quantity of code blocks for a set of code blocks included in the set of multiple code blocks using the first quantity of resource elements in the symbol and a second quantity of resource elements per code block of the set of multiple code blocks. The encoding component 335 may be configured to cause the UE 115 or the network entity 105 to encode, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks. The communication interface 340 may be configured to cause the UE 115 or the network entity 105 to transmit the interleaved resource elements of the quantity of code blocks using at least the portion of the first quantity of resource elements of the symbol.

In some examples, to support determining the quantity of code blocks, the code block bundle size component 330 may be configured to cause the UE 115 or the network entity 105 to determine the quantity of code blocks within the set of code blocks using a total quantity of code blocks of the set of multiple code blocks of the transport block and a quantity of symbols allocated for transmission of the transport block.

In some examples, the code block total component 355 may be configured to cause the UE 115 or the network entity 105 to determine the total quantity of code blocks using a transport block size of the transport block.

In some examples, the symbol quantity component 360 may be configured to cause the UE 115 or the network entity 105 to determine the quantity of symbols allocated for transmission of the transport block using a time domain resource allocation included in the one or more communication parameters.

In some examples, to support determining the quantity of code blocks, the code block bundle size component 330 may be configured to cause the UE 115 or the network entity 105 to determine the quantity of code blocks within the set of code blocks using an average quantity of resource elements per symbol allocated for transmission of the transport block and the second quantity of resource elements per code block.

In some examples, the code block size component 365 may be configured to cause the UE 115 or the network entity 105 to determine the second quantity of resource elements per code block using a maximum code block size, a coding rate for the transport block, a modulation order for the transport block, and a rank associated with transmission of the transport block.

In some examples, the one or more communication parameters include a frequency domain resource allocation, a modulation and coding scheme, a rank associated with transmission of the transport block, a time domain resource allocation, a maximum code block size, or any combination thereof. In some examples, the quantity of code blocks is determined using the one or more communication parameters.

In some examples, the capability component 350 may be configured to cause the UE 115 or the network entity 105 to participate in communication of a maximum supported quantity of code blocks for the set of code blocks including the resource elements that are to be interleaved, where the resource elements included in the first code block of the set of code blocks are interleaved with the resource elements included in the one or more additional code blocks in the set of code blocks in accordance with the maximum supported quantity of code blocks.

In some examples, the control signaling interface 325 may be configured to cause the UE 115 or the network entity 105 to participate in communication of one or more communication parameters associated with a transmission of a transport block including a set of multiple code blocks, where the one or more communication parameters are indicative of a first quantity of resource elements included in an symbol allocated for the transmission of the transport block. In some examples, the code block bundle size component 330 may be configured to cause the UE 115 or the network entity 105 to determine a quantity of code blocks for a set of code blocks included in the set of multiple code blocks using the first quantity of resource elements in the symbol and a second quantity of resource elements per code block of the set of multiple code blocks. In some examples, the communication interface 340 may be configured to cause the UE 115 or the network entity 105 to receive, using at least a portion of the first quantity of resource elements of the symbol, the set of code blocks, where resource elements included in a first code block in the set of code blocks are interleaved with resource elements included in one or more additional code blocks in the set of code blocks. The decoding component 345 may be configured to cause the UE 115 or the network entity 105 to decode each code block of the set of code blocks in accordance with the resource elements included in the first code block being interleaved with resource elements included in the one or more additional code blocks.

In some examples, to support determining the quantity of code blocks, the code block bundle size component 330 may be configured to cause the UE 115 or the network entity 105 to determine the quantity of code blocks within the set of code blocks using a total quantity of code blocks of the set of multiple code blocks of the transport block and a quantity of symbols allocated for transmission of the transport block.

In some examples, the code block total component 355 may be configured to cause the UE 115 or the network entity 105 to determine the total quantity of code blocks using a transport block size of the transport block.

In some examples, the symbol quantity component 360 may be configured to cause the UE 115 or the network entity 105 to determine the quantity of symbols allocated for receipt of the transport block using a time domain resource allocation included in the one or more communication parameters.

In some examples, to support determining the quantity of code blocks, the code block bundle size component 330 may be configured to cause the UE 115 or the network entity 105 to determine the quantity of code blocks within the set of code blocks using an average quantity of resource elements per symbol allocated for receipt of the transport block and the second quantity of resource elements per code block.

In some examples, the code block size component 365 may be configured to cause the UE 115 or the network entity 105 to determine the second quantity of resource elements per code block using a maximum code block size, a coding rate for the transport block, a modulation order for the transport block, and a rank associated with receipt of the transport block.

In some examples, the one or more communication parameters include a frequency domain resource allocation, a modulation and coding scheme, a rank associated with receipt of the transport block, a time domain resource allocation, a maximum code block size, or any combination thereof. In some examples, the quantity of code blocks is determined using the one or more communication parameters.

In some examples, the capability component 350 may be configured to cause the UE 115 or the network entity 105 to participate in communication of a maximum supported quantity of code blocks for the set of code blocks including the resource elements that are to be interleaved, where the resource elements of the first code block are interleaved with the resource elements included in the one or more additional code blocks in the set of code blocks in accordance with the maximum supported quantity of code blocks.

By including or configuring a processing system 320 for operation in a processing system 320 as described herein, the processing system 320 may support techniques for improved frequency diversity, resulting in improved signal quality and reduced interference.

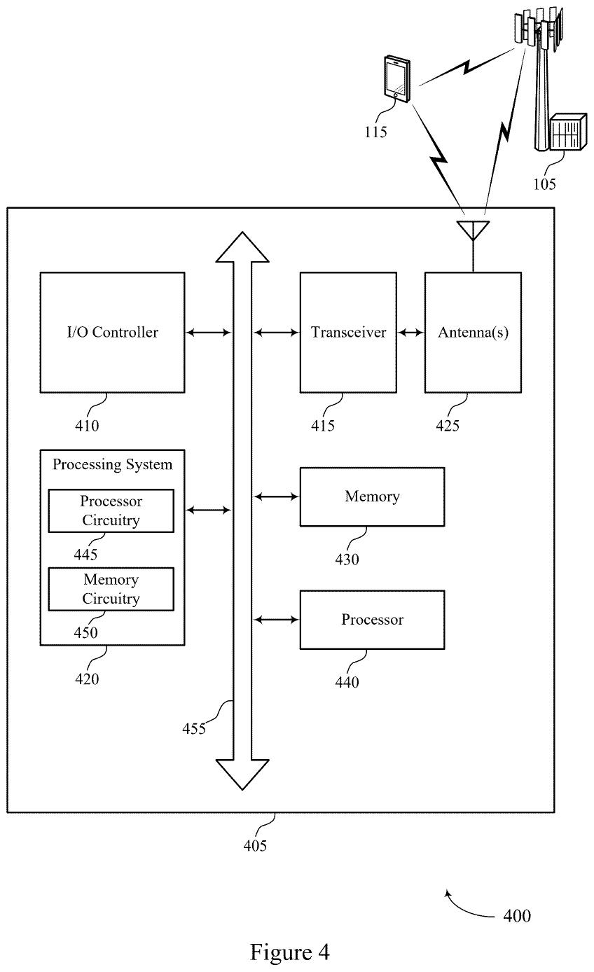

FIG. 4 shows an example of a system 400 including a device 405 that supports dynamic code block bundle interleaving. The device 405 may be an example of or include components of UE 115. The device 405 may communicate (such as wirelessly) with one or more other devices (such as network entities 105, UEs 115). The device 405 may include components for transmitting and receiving communication, which may include a processing system 420, an input/output (I/O) controller, such as an I/O controller 410, a transceiver 415, antenna(s) 425, a memory 430, and a processor 440. Components of the device 405 may be coupled (such as operatively, communicatively, functionally, electronically, electrically, in electronic communication) a bus 455.

The transceiver 415 may support bi-directional communication via antenna(s) 425, and may support transmission operations, reception operations, or both, as described herein. The transceiver 415 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 405). The transceiver 415 may modulate symbols and provide the modulated symbols to antenna(s) 425 for transmission, and demodulate symbols from signals received using antenna(s) 425.

The processor 440 may be a general-purpose processing component that supports various operations (such as applications) of the device 405. The memory 430 may be a general-purpose storage component that stores code executable by the processor 440. Such code may include instructions that, when executed by the processor 440, cause the device 405 to perform various functions (such as to support an application of the device 405). The I/O controller 410 may manage inputs and outputs for the device 405, may manage peripherals not integrated into the device 405, or may represent a physical connection (such as port) to an external peripheral. The processor 440 may interact with a modem, a keyboard, a mouse, a touchscreen, or other device (such as via I/O controller 410). In some implementations, a user may interact with the device 405 via the I/O controller 410 or via hardware components controlled by the I/O controller 410.

The processing system 420 may be an example of a processing system 140 or a processing system 300. For example, the processing system 420 may include processor circuitry 445 and memory circuitry 450 that stores code, and may be configured to cause the device 405 to perform operations that support dynamic code block bundle interleaving. Although the processing system 420 is illustrated as a separate component, which may involve a separate chip, chipset, or other module, in some implementations, one or more functions described with reference to the processing system 420 may be supported by or performed by a transceiver 415, antenna(s) 425, a processor 440, memory 430, or any combination thereof, such that a processing system 420 may include one or more of a transceiver 415, antenna(s) 425, a processor 440, memory 430, or any combination thereof.

By including or configuring the processing system 420 for operation in the device 405 as described herein, may support techniques for improved frequency diversity, resulting in improved signal quality and reduced interference.

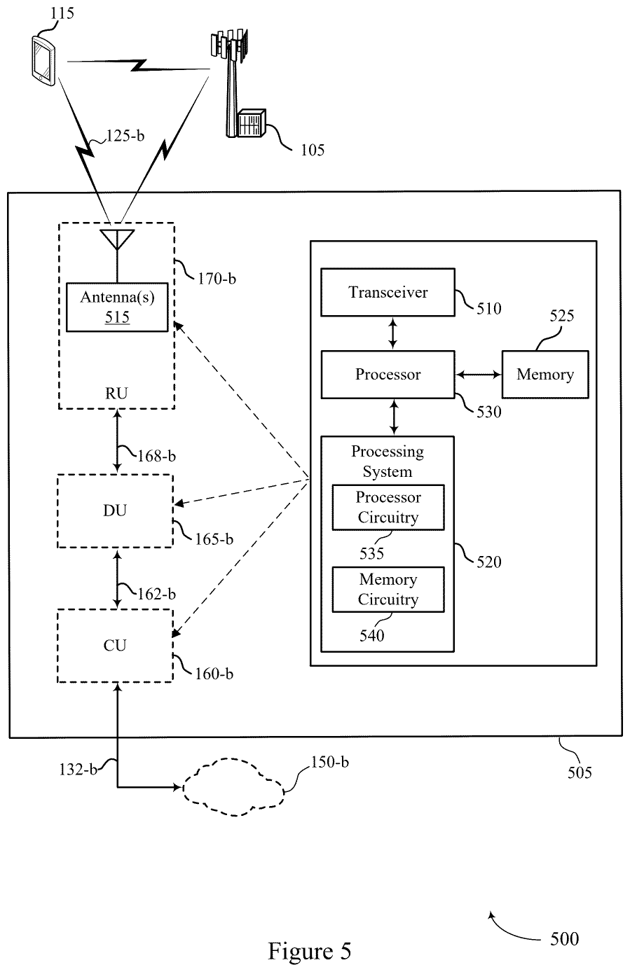

FIG. 5 shows an example of a system 500 including a device 505 that supports dynamic code block bundle interleaving. The device 505 may communicate (such as via one or more wired interfaces or one or more wireless interfaces) with other network devices or network equipment such as a core network 150-b, other network entities 105, UEs 115, or any combination thereof. The device 505 may include components for transmitting and receiving communication, which may include a processing system 520, a transceiver 510, antenna(s) 515, a memory 525, and a processor 530. Components of the device 505 may be coupled (such as operatively, communicatively, functionally, electronically, electrically, in electronic communication) via one or more interfaces.

The transceiver 510 may communicate bi-directionally with another transceiver via wired or wireless links, and may support transmission operations, reception operations, or both, as described herein. The transceiver 510 may include a modem to modulate and demodulate signals, to provide the modulated signals for transmission (such as via antenna(s) 515, via a wired interface), and to demodulate received signals (such as received via antenna(s) 515, received via a wired interface). The transceiver 510 may be operable to support communication via one or more communication links (such as a communication link 125-b, a backhaul link 132-b, a midhaul link 162-b, fronthaul link 168-b).

The processor 530 may be a general-purpose processing component that supports various operations (such as applications) of the device 505. The memory 525 may be a general-purpose storage component that stores code executable by the processor 530. Such code may include instructions that, when executed by the processor 530, cause the device 505 to perform various functions (such as to support an application of the device 505).

For examples in which the device 505 is a network entity 105 in a disaggregated architecture, one or more components of the device 505 may be located at one or more of a CU 160-b, a DU 165-b, or an RU 170-b, one or more of which may include aspects of the processing system 520, the processor 530, the memory 525, or the transceiver 510. Functions of the device 505 may be performed at different components or an operation may be divided between different components (such as different functions being supported by aspects of the CU 160-b, the DU 165-b, or the RU 170-b, the transceiver 510, the processor 530, the memory 525, the processing system 520, or any combination thereof). For example, the processing system 520 may be a component of one or more of the CU 160-b, the DU 165-b, or the RU 170-b. In some examples, interfaces between components of device 505 (such as CU 160-b, DU 165-b, RU 170-b) may support communication at a protocol layer or between protocol layers of a protocol stack.

In some examples, the processing system 520 may manage aspects of communication with the core network 150-b (such as via a backhaul link 132). For example, the processing system 520 may manage the transfer of data communication for UEs 115 with a gateway of the core network 150-b. In some examples, the processing system 520 may manage communication with one or more other network entities 105 and may include a controller or scheduler for controlling communication with UEs 115 (such as in cooperation with the one or more other network entities 105). In some examples, the processing system 520 may support an interface (such as X2 interface, Xn interface) to provide communication between network entities 105.

The processing system 520 may be an example of a processing system 145 or a processing system 300. For example, the processing system 520 may include processor circuitry 535 and memory circuitry 540 that stores code, and the processing system 520 may be configured to cause the device 505 to perform operations that support dynamic code block bundle interleaving. Although the processing system 520 is illustrated as a separate component, which may involve a separate chip, chipset, or other module, in some implementations, one or more functions described with reference to the processing system 520 may be supported by or performed by a transceiver 510, antenna(s) 515, a processor 530, memory 525, or any combination thereof, such that a processing system 520 may include one or more of a transceiver 510, antenna(s) 515, a processor 530, memory 525, or any combination thereof. Further, processor circuitry 535 and memory circuitry 540 each may be implemented at the device 505 in accordance with an aggregated architecture, or the processor circuitry 535 and the memory circuitry 540 may be implemented at one or more of a CU 160-b, a DU 165-b, or an RU 170-b in accordance with a disaggregated architecture.

By including or configuring the processing system 520 for operation in the device 505 as described herein, may support techniques for improved frequency diversity, resulting in improved signal quality and reduced interference (e.g., improved communication reliability).

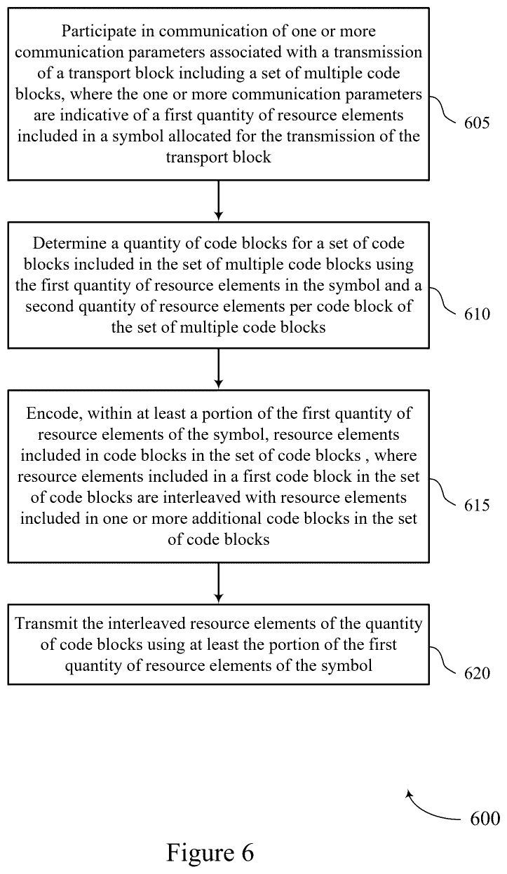

FIG. 6 shows an example of a method 600 that supports dynamic code block bundle interleaving. Operations of the method 600 may be performed by a UE 115 or a network entity 105 or respective components (such as using a processing system configured to cause the respective device to perform one or more of the operations), as described herein.

At 605, the method may include participating in communication of one or more communication parameters associated with a transmission of a transport block including a set of multiple code blocks, where the one or more communication parameters are indicative of a first quantity of resource elements included in a symbol allocated for the transmission of the transport block. In some examples, aspects of the operations of 605 may be performed by a control signaling interface 325.

At 610, the method may include determining a quantity of code blocks for a set of code blocks included in the set of multiple code blocks using the first quantity of resource elements in the symbol and a second quantity of resource elements per code block of the set of multiple code blocks. In some examples, aspects of the operations of 610 may be performed by a code block bundle size component 330.

At 615, the method may include encoding, within at least a portion of the first quantity of resource elements of the symbol, resource elements included in code blocks in the set of code blocks, where resource elements included in a first code block in the set of code blocks are interleaved with resource elements included in one or more additional code blocks in the set of code blocks. In some examples, aspects of the operations of 615 may be performed by an encoding component 335.

At 620, the method may include transmitting the interleaved resource elements of the quantity of code blocks using at least the portion of the first quantity of resource elements of the symbol. In some examples, aspects of the operations of 620 may be performed by a communication interface 340.

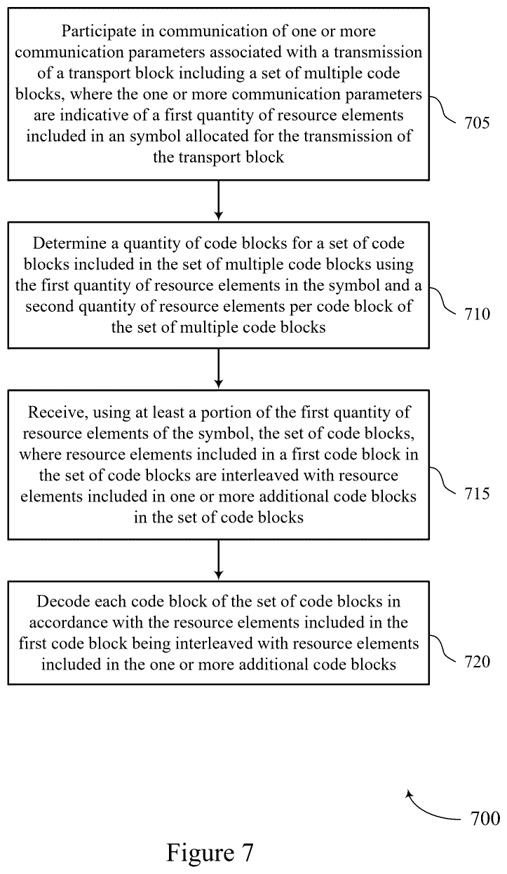

FIG. 7 shows an example of a method 700 that supports dynamic code block bundle interleaving. Operations of the method 700 may be performed by a UE 115 or a network entity 105 or respective components (such as using a processing system configured to cause the respective device to perform one or more of the operations), as described herein.

At 705, the method may include participating in communication of one or more communication parameters associated with a transmission of a transport block including a set of multiple code blocks, where the one or more communication parameters are indicative of a first quantity of resource elements included in an symbol allocated for the transmission of the transport block. In some examples, aspects of the operations of 705 may be performed by a control signaling interface 325.

At 710, the method may include determining a quantity of code blocks for a set of code blocks included in the set of multiple code blocks using the first quantity of resource elements in the symbol and a second quantity of resource elements per code block of the set of multiple code blocks. In some examples, aspects of the operations of 710 may be performed by a code block bundle size component 330.

At 715, the method may include receiving, using at least a portion of the first quantity of resource elements of the symbol, the set of code blocks, where resource elements included in a first code block in the set of code blocks are interleaved with resource elements included in one or more additional code blocks in the set of code blocks. In some examples, aspects of the operations of 715 may be performed by a communication interface 340.

At 720, the method may include decoding each code block of the set of code blocks in accordance with the resource elements included in the first code block being interleaved with resource elements included in the one or more additional code blocks. In some examples, aspects of the operations of 720 may be performed by a decoding component 345.

The following includes one or more aspects of the present disclosure:

Aspect 1: A method for wireless communications at a wireless device, comprising: participating in communication of one or more communication parameters associated with a transmission of a transport block comprising a plurality of code blocks, wherein the one or more communication parameters are indicative of a first quantity of resource elements included in a symbol allocated for the transmission of the transport block; determining a quantity of code blocks for a set of code blocks included in the plurality of code blocks using the first quantity of resource elements in the symbol and a second quantity of resource elements per code block of the plurality of code blocks; encoding, within at least a portion of the first quantity of resource elements of the symbol, resource elements included in code blocks in the set of code blocks, wherein resource elements included in a first code block in the set of code blocks are interleaved with resource elements included in one or more additional code blocks in the set of code blocks; and transmitting the interleaved resource elements of the quantity of code blocks using at least the portion of the first quantity of resource elements of the symbol.

Aspect 2: The method of aspect 1, wherein determining the quantity of code blocks comprises: determining the quantity of code blocks within the set of code blocks using a total quantity of code blocks of the plurality of code blocks of the transport block and a quantity of symbols allocated for transmission of the transport block.

Aspect 3: The method of aspect 2, further comprising: determining the total quantity of code blocks using a transport block size of the transport block.

Aspect 4: The method of any of aspects 2 through 3, further comprising: determining the quantity of symbols allocated for transmission of the transport block using a time domain resource allocation included in the one or more communication parameters.

Aspect 5: The method of any of aspects 1 through 4, wherein determining the quantity of code blocks comprises: determining the quantity of code blocks within the set of code blocks using an average quantity of resource elements per symbol allocated for transmission of the transport block and the second quantity of resource elements per code block.

Aspect 6: The method of aspect 5, further comprising: determining the second quantity of resource elements per code block using a maximum code block size, a coding rate for the transport block, a modulation order for the transport block, and a rank associated with transmission of the transport block.

Aspect 7: The method of any of aspects 1 through 6, wherein the one or more communication parameters comprise a frequency domain resource allocation, a modulation and coding scheme, a rank associated with transmission of the transport block, a time domain resource allocation, a maximum code block size, or any combination thereof, the quantity of code blocks is determined using the one or more communication parameters.

Aspect 8: The method of any of aspects 1 through 7, further comprising: participating in communication of a maximum supported quantity of code blocks for the set of code blocks including the resource elements that are to be interleaved, wherein the resource elements included in the first code block of the set of code blocks are interleaved with the resource elements included in the one or more additional code blocks in the set of code blocks in accordance with the maximum supported quantity of code blocks.

Aspect 9: A method for wireless communications at a wireless device, comprising: participating in communication of one or more communication parameters associated with a transmission of a transport block comprising a plurality of code blocks, wherein the one or more communication parameters are indicative of a first quantity of resource elements included in an symbol allocated for the transmission of the transport block; determining a quantity of code blocks for a set of code blocks included in the plurality of code blocks using the first quantity of resource elements in the symbol and a second quantity of resource elements per code block of the plurality of code blocks; receiving, using at least a portion of the first quantity of resource elements of the symbol, the set of code blocks, wherein resource elements included in a first code block in the set of code blocks are interleaved with resource elements included in one or more additional code blocks in the set of code blocks; and decoding each code block of the set of code blocks in accordance with the resource elements included in the first code block being interleaved with resource elements included in the one or more additional code blocks.

Aspect 10: The method of aspect 9, wherein determining the quantity of code blocks comprises: determining the quantity of code blocks within the set of code blocks using a total quantity of code blocks of the plurality of code blocks of the transport block and a quantity of symbols allocated for transmission of the transport block.

Aspect 11: The method of aspect 10, further comprising: determining the total quantity of code blocks using a transport block size of the transport block.

Aspect 12: The method of any of aspects 10 through 11, further comprising: determining the quantity of symbols allocated for receipt of the transport block using a time domain resource allocation included in the one or more communication parameters.

Aspect 13: The method of any of aspects 9 through 12, wherein determining the quantity of code blocks comprises: determining the quantity of code blocks within the set of code blocks using an average quantity of resource elements per symbol allocated for receipt of the transport block and the second quantity of resource elements per code block.

Aspect 14: The method of aspect 13, further comprising: determining the second quantity of resource elements per code block using a maximum code block size, a coding rate for the transport block, a modulation order for the transport block, and a rank associated with receipt of the transport block.

Aspect 15: The method of any of aspects 9 through 14, wherein the one or more communication parameters comprise a frequency domain resource allocation, a modulation and coding scheme, a rank associated with receipt of the transport block, a time domain resource allocation, a maximum code block size, or any combination thereof, the quantity of code blocks is determined using the one or more communication parameters.

Aspect 16: The method of any of aspects 9 through 15, further comprising: participating in communication of a maximum supported quantity of code blocks for the set of code blocks including the resource elements that are to be interleaved, wherein the resource elements of the first code block are interleaved with the resource elements included in the one or more additional code blocks in the set of code blocks in accordance with the maximum supported quantity of code blocks.

Aspect 17: A wireless device for wireless communications, comprising a processing system that includes processor circuitry and memory circuitry that stores code, the processing system configured to cause the wireless device to perform a method of any of aspects 1 through 8.

Aspect 18: A wireless device for wireless communications, comprising at least one means for performing a method of any of aspects 1 through 8.

Aspect 19: A non-transitory computer-readable medium storing code for wireless communications, the code comprising instructions executable by one or more processors to perform a method of any of aspects 1 through 8.

Aspect 20: A wireless device for wireless communications, comprising a processing system that includes processor circuitry and memory circuitry that stores code, the processing system configured to cause the wireless device to perform a method of any of aspects 9 through 16.

Aspect 21: A wireless device for wireless communications, comprising at least one means for performing a method of any of aspects 9 through 16.

Aspect 22: A non-transitory computer-readable medium storing code for wireless communications, the code comprising instructions executable by one or more processors to perform a method of any of aspects 9 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the phrase “a set” shall be construed as including the possibility of a set with one member. That is, the phrase “a set” shall be construed in the same manner as “one or more.”

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
participate in communication of one or more communication parameters associated with a transmission of a transport block comprising a plurality of code blocks, wherein the one or more communication parameters are indicative of a first quantity of resource elements included in a symbol allocated for the transmission of the transport block;
determine a quantity of code blocks for a set of code blocks included in the plurality of code blocks using the first quantity of resource elements in the symbol and a second quantity of resource elements per code block of the plurality of code blocks;
encode, within at least a portion of the first quantity of resource elements of the symbol, resource elements included in code blocks in the set of code blocks, wherein resource elements included in a first code block in the set of code blocks are interleaved with resource elements included in one or more additional code blocks in the set of code blocks; and
transmit the interleaved resource elements of the quantity of code blocks using at least the portion of the first quantity of resource elements of the symbol.

2. The wireless device of claim 1, wherein, to determine the quantity of code blocks, the one or more processors are individually or collectively operable to execute the code to cause the wireless device to:
determine the quantity of code blocks within the set of code blocks using a total quantity of code blocks of the plurality of code blocks of the transport block and a quantity of symbols allocated for transmission of the transport block.

3. The wireless device of claim 2, wherein the one or more processors are individually or collectively further operable to execute the code to cause the wireless device to:
determine the total quantity of code blocks using a transport block size of the transport block.

4. The wireless device of claim 2, wherein the one or more processors are individually or collectively further operable to execute the code to cause the wireless device to:
determine the quantity of symbols allocated for transmission of the transport block using a time domain resource allocation included in the one or more communication parameters.

5. The wireless device of claim 1, wherein, to determine the quantity of code blocks, the one or more processors are individually or collectively operable to execute the code to cause the wireless device to:
determine the quantity of code blocks within the set of code blocks using an average quantity of resource elements per symbol allocated for transmission of the transport block and the second quantity of resource elements per code block.

6. The wireless device of claim 5, wherein the one or more processors are individually or collectively further operable to execute the code to cause the wireless device to:
determine the second quantity of resource elements per code block using a maximum code block size, a coding rate for the transport block, a modulation order for the transport block, and a rank associated with transmission of the transport block.

7. The wireless device of claim 1, wherein:
the one or more communication parameters comprise a frequency domain resource allocation, a modulation and coding scheme, a rank associated with transmission of the transport block, a time domain resource allocation, a maximum code block size, or any combination thereof, and
the quantity of code blocks is determined using the one or more communication parameters.

8. The wireless device of claim 1, wherein the one or more processors are individually or collectively further operable to execute the code to cause the wireless device to:
participate in communication of a maximum supported quantity of code blocks for the set of code blocks including the resource elements that are to be interleaved, wherein the resource elements included in the first code block of the set of code blocks are interleaved with resource elements included in the one or more additional code blocks in the set of code blocks in accordance with the maximum supported quantity of code blocks.

9. A wireless device, comprising:
one or more memories storing processor-executable code; and
one or more processors coupled with the one or more memories and individually or collectively operable to execute the code to cause the wireless device to:
participate in communication of one or more communication parameters associated with a transmission of a transport block comprising a plurality of code blocks, wherein the one or more communication parameters are indicative of a first quantity of resource elements included in an symbol allocated for the transmission of the transport block;
determine a quantity of code blocks for a set of code blocks included in the plurality of code blocks using the first quantity of resource elements in the symbol and a second quantity of resource elements per code block of the plurality of code blocks;
receive, using at least a portion of the first quantity of resource elements of the symbol, the set of code blocks, wherein resource elements included in a first code block in the set of code blocks are interleaved with resource elements included in one or more additional code blocks in the set of code blocks; and
decode each code block of the set of code blocks in accordance with the resource elements included in the first code block being interleaved with resource elements included in the one or more additional code blocks.

10. The wireless device of claim 9, wherein, to determine the quantity of code blocks, the one or more processors are individually or collectively operable to execute the code to cause the wireless device to:
determine the quantity of code blocks within the set of code blocks using a total quantity of code blocks of the plurality of code blocks of the transport block and a quantity of symbols allocated for transmission of the transport block.

11. The wireless device of claim 10, wherein the one or more processors are individually or collectively further operable to execute the code to cause the wireless device to:
determine the total quantity of code blocks using a transport block size of the transport block.

12. The wireless device of claim 10, wherein the one or more processors are individually or collectively further operable to execute the code to cause the wireless device to:
determine the quantity of symbols allocated for receipt of the transport block using a time domain resource allocation included in the one or more communication parameters.

13. The wireless device of claim 9, wherein, to determine the quantity of code blocks, the one or more processors are individually or collectively operable to execute the code to cause the wireless device to:
determine the quantity of code blocks within the set of code blocks using an average quantity of resource elements per symbol allocated for receipt of the transport block and the second quantity of resource elements per code block.

14. The wireless device of claim 13, wherein the one or more processors are individually or collectively further operable to execute the code to cause the wireless device to:
determine the second quantity of resource elements per code block using a maximum code block size, a coding rate for the transport block, a modulation order for the transport block, and a rank associated with receipt of the transport block.

15. The wireless device of claim 9, wherein:
the one or more communication parameters comprise a frequency domain resource allocation, a modulation and coding scheme, a rank associated with receipt of the transport block, a time domain resource allocation, a maximum code block size, or any combination thereof, and
the quantity of code blocks is determined using the one or more communication parameters.

16. The wireless device of claim 9, wherein the one or more processors are individually or collectively further operable to execute the code to cause the wireless device to:
participate in communication of a maximum supported quantity of code blocks for the set of code blocks including the resource elements that are to be interleaved, wherein the resource elements of the first code block are interleaved with the resource elements included in the one or more additional code blocks in the set of code blocks in accordance with the maximum supported quantity of code blocks.

17. A method for wireless communications at a wireless device, comprising:
participating in communication of one or more communication parameters associated with a transmission of a transport block comprising a plurality of code blocks, wherein the one or more communication parameters are indicative of a first quantity of resource elements included in a symbol allocated for the transmission of the transport block;
determining a quantity of code blocks for a set of code blocks included in the plurality of code blocks using the first quantity of resource elements in the symbol and a second quantity of resource elements per code block of the plurality of code blocks;
encoding, within at least a portion of the first quantity of resource elements of the symbol, resource elements included in code blocks in the set of code blocks, wherein resource elements included in a first code block in the set of code blocks are interleaved with resource elements included in one or more additional code blocks in the set of code blocks; and
transmitting the interleaved resource elements of the quantity of code blocks using at least the portion of the first quantity of resource elements of the symbol.

18. The method of claim 17, wherein determining the quantity of code blocks comprises:
determining the quantity of code blocks within the set of code blocks using a total quantity of code blocks of the plurality of code blocks of the transport block and a quantity of symbols allocated for transmission of the transport block.

19. The method of claim 18, further comprising:
determining the total quantity of code blocks using a transport block size of the transport block.

20. The method of claim 18, further comprising:
determining the quantity of symbols allocated for transmission of the transport block using a time domain resource allocation included in the one or more communication parameters.
